(19) United States
(12) Patent Application Publication
(10) Pub. No.: US 2025/0035203 A1
(43) Pub. Date: Jan. 30, 2025

(54) MUTE KNOB HEADGEAR AND VR HEAD-MOUNTED DISPLAY

(71) Applicant: Shenzhen Hongjiantou Technology Co., Ltd., Shenzhen (CN)

(72) Inventor: Zhinan Zhang, Shenzhen (CN)

(21) Appl. No.: 18/679,523

(22) Filed: May 31, 2024

(30) Foreign Application Priority Data
Jul. 26, 2023 (CN) 202321984074.4

(51) Int. Cl. F16H 57/00; F16M 13/04; G06F 1/16

(52) U.S. Cl. CPC F16H 57/0006; F16M 13/04; G06F 1/163

(57) ABSTRACT

Disclosed is a mute knob headgear which includes: two rack belts respectively connected to a VR head-mounted display; and a knob assembly provided at one end of the two rack belts away from the VR head-mounted display and in meshing connection with the two rack belts. The knob assembly is configured to adjust the tightness of the two rack belts, and includes a housing and a gear, a rotary wheel, a pawl, and a soft rubber ring provided in the housing. The present application drives the rotation of the gear by rotating the rotary wheel and then drives the rack to adjust the tightness; when rotating, the pawl and the soft rubber ring are in friction fit; when stopping the rotation, they can jam each other to prevent reverse rotation. The cooperation between the soft rubber ring and the pawl does not produce any sound and achieves infinite adjustment.

### CROSS REFERENCES TO RELATED APPLICATION

The present application claims the benefit of Chinese Patent Application No. 202321984074.4 filed on Jul. 26, 2023, the contents of which are incorporated herein by reference in their entirety.

### TECHNICAL FIELD

The present application relates to the technical field of VR accessories, and particularly relates to a mute knob headgear and VR head-mounted display.

### BACKGROUND ART

At present, the tightening knobs on the back of VR headgears on the market are adjusted using a ratchet structure. Each tooth of rotation will cause the pawl to jam and produce significant noise. However, when a user wearing a VR headgear, because the VR headgear is relatively close to the ears, the significant noise generated during the adjustment can cause discomfort to the user. Also, because the ratchet structure is one-tooth one-gear, it cannot be infinitely adjusted.

### SUMMARY

The purpose of the present application is to provide a mute knob headgear and a VR head-mounted display, aiming to solve the problems of loud noise and inability to achieve infinite adjustment of existing VR headgears using a ratchet structure.

In order to solve the above technical problem, the object of the present application is achieved by the following technical solutions: providing a mute knob headgear applied to a VR head-mounted display, the mute knob headgear including:
two rack belts respectively connected to two sides of the VR head-mounted display;
a knob assembly provided at one end of the two rack belts away from the VR head-mounted display and in meshing connection with the two rack belts, wherein the knob assembly is configured to adjust the tightness of the two rack belts;
wherein the knob assembly includes a housing and a gear, a rotary wheel, a pawl, and a soft rubber ring provided in the housing; the gear is rotatably mounted and is in meshing connection with two rack belts; the rotary wheel is coaxially connected to the gear and the outside of the rotary wheel is exposed from the outside of the housing; the soft rubber ring is fixed in the housing; the pawl is provided on the rotary wheel and is located on an inner ring of the soft rubber ring; and the pawl abuts against the inner ring of the soft rubber ring.

Further, the housing includes a base housing and an outer housing which are in covering connection with each other, and two of the rack belts are slidably inserted into the housing at an end remote from the VR head-mounted display and in meshing connection with the gear.

Further, the base housing is provided an annular ring opening, and the soft rubber ring is fixedly provided on the annular ring opening.

Further, the rotary wheel is sandwiched between the base housing and the outer housing, and the knob assembly further includes a mounting cover that covers the rotary wheel from the annular ring opening to retain the pawl within the rotary wheel.

Further, the outer housing is provided with a connecting post extending through the gear and rotary wheel and connected to the mounting cover.

Further, the rotary wheel is provided with an arcuate groove position and the soft rubber ring is in the arcuate groove position.

Further, the rotary wheel is provided with a pawl groove in communication with the arcuate groove position, and the pawl is mounted in the pawl groove and abuts against the inner ring of the soft rubber ring.

Further, a plurality of pawl grooves are provided and distributed in a circumferential direction, and a plurality of pawls are provided and mounted in the plurality of pawl grooves in a one-to-one correspondence manner.

Further, the pawl is provided with an elastic portion that abuts against an inner wall of the pawl groove and forms an elastic force to lift the pawl toward the inner ring of the soft rubber ring so that the pawl elastically abuts against the inner ring of the soft rubber ring.

An embodiment of the present application also provides a VR head-mounted display including the mute knob headgear as described above.

An embodiment of the present application provides a mute knob headgear and a VR head-mounted display. The mute knob headgear includes two rack belts respectively connected to two sides of the VR head-mounted display; and a knob assembly provided at one end of the two rack belts away from the VR head-mounted display and in meshing connection with the two rack belts, wherein the knob assembly is configured to adjust the tightness of the two rack belts; wherein the knob assembly includes a housing and a gear, a rotary wheel, a pawl, and a soft rubber ring provided in the housing; the gear is rotatably mounted and is in meshing connection with two rack belts; the rotary wheel is coaxially connected to the gear and the outside of the rotary wheel is exposed from the outside of the housing; the soft rubber ring is fixed in the housing; the pawl is provided on the rotary wheel and is located on an inner ring of the soft rubber ring; and the pawl abuts against the inner ring of the soft rubber ring. The embodiment of the present application drives the rotation of the gear by rotating the rotary wheel and then drives the rack to adjust the tightness; when rotating, the pawl and the soft rubber ring are in friction fit; when stopping the rotation, they can jam each other to prevent reverse rotation. The cooperation between the soft rubber ring and the pawl does not produce any sound and achieves infinite adjustment.

### BRIEF DESCRIPTION OF THE DRAWINGS

In order to more clearly illustrate the technical solutions of the embodiments of the present application, a brief description will be given below of the accompanying drawings which are required to be used in the description of the embodiments. It is obvious that the drawings in the description below are only some embodiments of the present application, and it would be obvious for a person skilled in the art to obtain other drawings according to these drawings without involving any inventive effort.

FIG. 1 is a schematic diagram of the overall structure of a VR head-mounted display provided in an embodiment of the present application;

FIG. 2 is a schematic diagram of the decomposed structure of the mute knob headgear provided in an embodiment of the present application;

FIG. 3 is a schematic diagram of another decomposed structure of the mute knob headgear provided in an embodiment of the present application; and

FIG. 4 is a schematic diagram of an enlarged structure of part A in FIG. 3.

### EXPLANATION OF SIGNS IN THE FIGURES

1, rack belt;
2, knob assembly; 21, base housing; 211, annular ring opening; 22, outer housing; 23, gear; 24, rotary wheel; 241, arcuate groove position; 242, pawl groove; 25, pawl; 251, elastic portion; 26, soft rubber ring; and 27, mounting cover;
3, overhead belt; and
4, VR head-mounted display.

### DETAILED DESCRIPTION

The technical solutions in the embodiments of the present application will be described clearly and completely in conjunction with the accompanying drawings in the embodiments of the present application. Obviously, the described embodiments are a part of the embodiments of the present application, rather than all the embodiments. Based on the embodiments of the present application, all other embodiments obtained by a person of ordinary skill in the art without inventive effort fall within the scope of the present application.

It should be understood that when used in this specification and the accompanying claims, the terms “including” and “comprising” indicate the presence of the described features, whole, step, operation, element, and/or assembly, but do not exclude the presence or addition of one or more other features, whole, step, operation, element, assembly, and/or combination thereof.

It should also be understood that the terms used in the specification of the present application are only for the purpose of describing specific embodiments and are not intended to limit this present application. As used in the specification and the accompanying claims of the present application, unless the context clearly indicates other circumstances, singular forms of “a”, “an”, and “the” are intended to include plural forms.

It should be further understood that the term “and/or” as used in the description of the present application and the accompanying claims refers to and includes any and all possible combinations of one or more of the associated listed items.

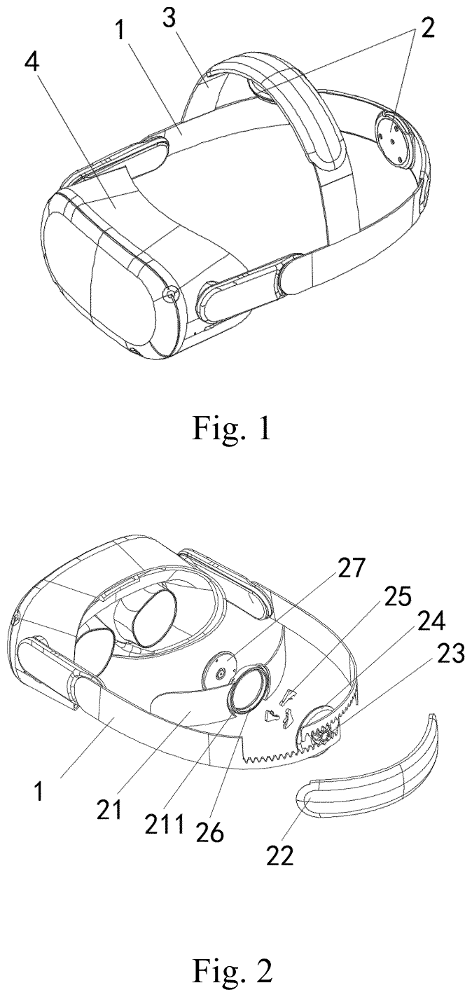

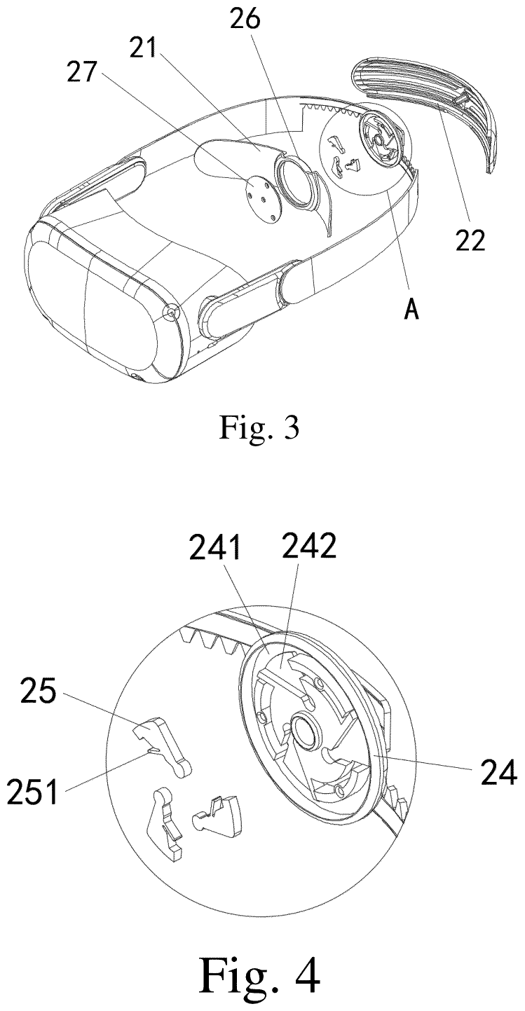

In conjunction with FIGS. 1, 2, and 3, the embodiment of the present application provides a mute knob headgear applied to a VR head-mounted display 4. The mute knob headgear includes two rack belts 1 and a knob assembly 2. The two rack belts 1 are respectively connected to two sides of the VR head-mounted display 4. The knob assembly 2 is provided at one end of the two rack belts 1 away from the VR head-mounted display 4 and is in meshing connection with the two rack belts 1. The knob assembly 2 is configured to adjust the tightness of the two rack belts 1.

The knob assembly 2 includes a housing and a gear 23, a rotary wheel 24, a pawl 25, and a soft rubber ring 26 provided in the housing. The gear 23 is rotatably mounted and is in meshing connection with two rack belts 1. The rotary wheel 24 is coaxially connected to the gear 23 and the outside of the rotary wheel 24 is exposed from the outside of the housing. The soft rubber ring 26 is fixed in the housing. The pawl 25 is provided on the rotary wheel 24 and is located on an inner ring of the soft rubber ring 26. The pawl 25 abuts against the inner ring of the soft rubber ring 26.

In this embodiment, the rotary wheel 24 is exposed from the outside of the housing, and the rotary wheel 24 is rotated by the exposed portion. The rotary wheel 24 drives the gear 23 to rotate synchronously, and the gear 23 can drive the two rack belts 1 to perform a tightness adjustment action when rotating. At the same time, the rotary wheel 24 drives the pawl 25 to rotate, so that the pawl 25 and the soft rubber ring 26 are in friction fit. When stopping the rotation, the pawl 25 and the soft rubber ring 26 can be jammed with each other to prevent reverse rotation. Since the soft rubber ring 26 is made of soft rubber, the pawl 25 does not generate sound when rubbing the soft rubber ring 26, achieving infinite adjustment.

In some embodiments, the knob assembly 2 of the present application may also be used in a position of an overhead belt 3, such as the headgear position and the position of the overhead belt 3 shown in FIG. 1.

In an embodiment, the housing includes a base housing 21 and an outer housing 22 which are in covering connection with each other. Two of the rack belts 1 are slidably inserted into the housing at an end remote from the VR head-mounted display 4 and in meshing connection with the gear 23.

In this embodiment, the base housing 21 and the outer housing 22 are both in an arcuate sheet shape. One end of the two rack belts 1 remote from the VR head-mounted display 4 is respectively inserted into the interior of the housing from two ends of the housing. The two rack belts 1 are respectively in meshing connection with the upper and lower sides of the gear 23, such that when the gear 23 rotates, the two rack belts 1 can be driven to move in a reverse direction so as to achieve tightness adjustment.

In an embodiment, the base housing 21 is provided with an annular ring opening 211. The soft rubber ring 26 is fixedly provided on the annular ring opening 211 by two-shot molding or over-molding.

In an embodiment, the knob assembly 2 further includes a mounting cover 27. The outer housing 22 is provided with a connecting post extending through the gear 23 and the rotary wheel 24 and fixedly connected to the mounting cover 27 by means of a screw.

In some installations, the mounting cover 27 presses the base housing 21 by securing the mounting cover 27 to the outer housing 22 from the annular ring opening 211 such that the base housing 21 and the outer housing 22 are fixedly secured to one another to remain stable such that the knob assembly 2 is stably sandwiched between the base housing 21 and the outer housing 22. In addition, the mounting cover 27 covers the rotary wheel 24 from the annular ring opening 211 to retain the pawl 25 within the rotary wheel 24 such that the pawl 25 remains stable.

In an embodiment, the rotary wheel 24 is provided with an arcuate groove position 241, and the soft rubber ring 26 is located in the arcuate groove position 241. The rotary wheel 24 is provided with a pawl groove 242. The pawl groove 242 communicates with the arcuate groove position 241. The pawl 25 is mounted in the pawl groove 242 and abuts against the inner ring of the soft rubber ring 26.

In this embodiment, referring to FIG. 4, the pawl 25 is mounted in the pawl groove 242. A small portion of the pawl 25 extends into the arcuate groove position 241 and abuts against the inner ring of the soft rubber ring 26, so that when the rotary wheel 24 drives the pawl 25 to rotate, a small portion of the pawl 25 extending into the arcuate groove position 241 performs a friction movement on the inner ring of the soft rubber ring 26, so as to achieve a noise-free and infinite adjustment.

Specifically, a plurality of pawl grooves 242 are provided and distributed in a circumferential direction. A plurality of pawls 25 are provided and mounted in the plurality of pawl grooves 242 in a one-to-one correspondence manner. Preferably, the pawl grooves 242 and the pawls 25 are respectively provided with three and uniformly distributed in the circumferential direction to improve the stability of the adjustment.

Specifically, in order to achieve that the pawl 25 always abuts against the inner ring of the soft rubber ring 26, the pawl 25 is provided with an elastic portion 251. The elastic portion 251 abuts against the side wall of the pawl groove 242, deforms, generates an elastic force by the deformation, and bounces the pawl 25 in the direction of the inner ring of the soft rubber ring 26, so that the pawl 25 elastically abuts against the inner ring of the soft rubber ring 26, thereby ensuring that the pawl 25 always abuts the inner ring of the soft rubber ring 26.

An embodiment of the present application also provides a VR head-mounted display including the mute knob headgear as described above.

The above is only the specific implementation method of the present application, and the scope of the present application is not limited to this. Any equivalent changes or replacements that can be easily thought of by technical personnel familiar with the technical field within the scope of disclosure in the present application should be covered within the scope of the present application. Therefore, the scope of the present application should be subject to the scope of the claims.

1. A mute knob headgear applied to a VR head-mounted display, comprising:
two rack belts respectively connected to two sides of the VR head-mounted display;
a knob assembly provided at one end of the two rack belts away from the VR head-mounted display and in meshing connection with the two rack belts, wherein the knob assembly is configured to adjust the tightness of the two rack belts;
wherein the knob assembly comprises a housing and a gear, a rotary wheel, a pawl, and a soft rubber ring provided in the housing; the gear is rotatably mounted and is in meshing connection with two rack belts; the rotary wheel is coaxially connected to the gear and the outside of the rotary wheel is exposed from the outside of the housing; the soft rubber ring is fixed in the housing; the pawl is provided on the rotary wheel and is located on an inner ring of the soft rubber ring; and the pawl abuts against the inner ring of the soft rubber ring.

2. The mute knob headgear of claim 1, wherein the housing comprises a base housing and an outer housing which are in covering connection with each other, and two of the rack belts are slidably inserted into the housing at an end remote from the VR head-mounted display and in meshing connection with the gear.

3. The mute knob headgear of claim 2, wherein the base housing is provided an annular ring opening, and the soft rubber ring is fixedly provided on the annular ring opening.

4. The mute knob headgear of claim 3, wherein the rotary wheel is sandwiched between the base housing and the outer housing, and the knob assembly further comprises a mounting cover that covers the rotary wheel from the annular ring opening to retain the pawl within the rotary wheel.

5. The mute knob headgear of claim 4, wherein the outer housing is provided with a connecting post extending through the gear and rotary wheel and connected to the mounting cover.

6. The mute knob headgear of claim 4, wherein the rotary wheel is provided with an arcuate groove position and the soft rubber ring is in the arcuate groove position.

7. The mute knob headgear of claim 6, wherein the rotary wheel is provided with a pawl groove in communication with the arcuate groove position, and the pawl is mounted in the pawl groove and abuts against the inner ring of the soft rubber ring.

8. The mute knob headgear of claim 7, wherein a plurality of pawl grooves are provided and distributed in a circumferential direction, and a plurality of pawls are provided and mounted in the plurality of pawl grooves in a one-to-one correspondence manner.

9. The mute knob headgear of claim 7, wherein the pawl is provided with an elastic portion that abuts against an inner wall of the pawl groove and forms an elastic force to lift the pawl toward the inner ring of the soft rubber ring so that the pawl elastically abuts against the inner ring of the soft rubber ring.

10. A VR head-mounted display comprising the mute knob headgear of claim 1.

11. The VR head-mounted display of claim 10, wherein the housing comprises a base housing and an outer housing which are in covering connection with each other, and two of the rack belts are slidably inserted into the housing at an end remote from the VR head-mounted display and in meshing connection with the gear.

12. The VR head-mounted display of claim 11, wherein the base housing is provided an annular ring opening, and the soft rubber ring is fixedly provided on the annular ring opening.

13. The VR head-mounted display of claim 12, wherein the rotary wheel is sandwiched between the base housing and the outer housing, and the knob assembly further comprises a mounting cover that covers the rotary wheel from the annular ring opening to retain the pawl within the rotary wheel.

14. The VR head-mounted display of claim 13, wherein the outer housing is provided with a connecting post extending through the gear and rotary wheel and connected to the mounting cover.

15. The VR head-mounted display of claim 13, wherein the rotary wheel is provided with an arcuate groove position and the soft rubber ring is in the arcuate groove position.

16. The VR head-mounted display of claim 15, wherein the rotary wheel is provided with a pawl groove in communication with the arcuate groove position, and the pawl is mounted in the pawl groove and abuts against the inner ring of the soft rubber ring.

17. The VR head-mounted display of claim 16, wherein a plurality of pawl grooves are provided and distributed in a circumferential direction, and a plurality of pawls are provided and mounted in the plurality of pawl grooves in a one-to-one correspondence manner.

18. The VR head-mounted display of claim 16, wherein the pawl is provided with an elastic portion that abuts against an inner wall of the pawl groove and forms an elastic force to lift the pawl toward the inner ring of the soft rubber ring so that the pawl elastically abuts against the inner ring of the soft rubber ring.
